(19) United States
(12) Patent Application Publication
(10) Pub. No.: US 2009/0274898 A1
(43) Pub. Date: Nov. 5, 2009

(54) PROCESS FOR PRODUCING OPTICAL FUNCTIONAL FILM, OPTICAL FUNCTIONAL FILM, POLARIZING PLATE, OPTICAL ELEMENT AND IMAGE DISPLAY DEVICE

(75) Inventors: Seiji Kondou, Ibaraki-shi (JP); Kentarou Yoshida, Ibaraki-shi (JP); Wataru Nagatake, Osaka (JP); Shouji Shibata, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/088,807

(22) PCT Filed: Aug. 23, 2006
(86) PCT No.: PCT/JP2006/316462

§ 371 Date: Mar. 31, 2008

(30) Foreign Application Priority Data
Sep. 29, 2005 (JP) 2005-284876

(51) Int. Cl. B32B 5/00; B05D 5/06

(52) U.S. Cl. 428/336; 427/162

(57) ABSTRACT

A process for producing an optical functional film having a polyimide layer is provided, which includes an application step of applying a coating liquid containing polyimide and having a viscosity γ of 100<γ<3000 mPa·s on a substrate film by a die coater having an upstream die lip and a downstream die lip, thereby forming a polyimide layer on the substrate film, in which D2≧50 μm and 0<D1−D2≦200 μm are satisfied, in which D1 represents a distance between a leading end of the upstream die lip and the substrate film and D2 represents a distance between a leading end of the downstream die lip and the substrate film.

### FIELD OF THE INVENTION

The present invention relates to a process for producing an optical functional film and an optical functional film, as well as a polarizing plate, an optical element and an image display device, each having the optical functional film.

### BACKGROUND OF THE INVENTION

In recent years, many liquid crystal display devices having excellent characteristics, such as low-profile, light-weight, and low power consumption characteristics are used as display devices of such as TV sets and personal computers. The liquid crystal display device of this type uses an optical functional film having resin layers exhibiting various optical performances such as polarization, optical compensation and antireflection, as well as a liquid crystal layer as a main element.

When unevenness in thickness is caused in a resin layer of the optical functional layer, interference unevenness is caused in transmitted light, which in turn deteriorates the performance of the optical functional layer, and hence an image display device (e.g., a liquid crystal display device, etc.) may have deteriorated display performances.

Conventionally, the optical functional film of the above type is produced by applying a coating liquid, which is prepared by dissolving a resin in a solvent, onto a substrate film, following various application methods using such as a slit die coater and a gravure coater (Patent Reference 1), and subjecting it to a drying step or the like.

Patent Document 1: Japanese Patent Application Laid-open No. Sho-62-140672.

Furthermore, in recent years, with the advance of the performance of the optical functional film, it has become critical for a resin layer, to which an optical performance is given, to be thinned and have an even thickness; however conventional thin film coating techniques attempt to realize uniform thickness merely by lowering the viscosity of a coating liquid to several tens mPa·s or lower, thus enabling a leveling effect or the like to be exhibited.

### SUMMARY OF THE INVENTION

### Means to Solve the Problems

However, in a method of using a low viscosity coating liquid, resin flow occurs locally on a substrate film with the coating liquid applied thereon during the shift from an application step, in which the coating liquid is applied onto the substrate film, to a drying step; and when the resin is cured with resin flow remained, bright spots due to repellent action on the coated surface, interference unevenness due to the difference in thickness of a resin layer at local areas, uneven retardation or the like may occur, which causes a problem that appearance defect is easy to occur. Therefore, according to the conventional application method, it is difficult to form on a substrate film a resin layer without defect appearance.

Especially, polyimide has been attracting attention because of its very excellent transparency, orientation and stretchability; however when a coating liquid containing the polyimide is to be applied by the conventional method, that is, when the viscosity of the coating liquid containing the polyimide is merely lowered, a good appearance may not be obtainable and furthermore there is a problem that appearance defect inherent to the polyimide may occur.

Accordingly, it is an object of the present invention to provide an optical functional film having less appearance defect by applying a coating liquid containing polyimide so as to have a thin and even thickness, when in preparation of an optical functional film using polyimide having excellent optical characteristics.

### Means to Solve the Problems

In order to solve the above problems, according to the present invention, there is provided a process for producing an optical functional film having a polyimide layer, which is characterized in that it comprises an application step of applying a coating liquid containing polyimide and having a viscosity γ of 100<γ<3000 mPa·s on a substrate film by a die coater having an upstream die lip and a downstream die lip, thereby forming a polyimide layer on the substrate film, in which D2≧50 μm and 0<D1−D2≦200 μm are satisfied, in which D1 represents a distance between a leading end of the upstream die lip and the substrate film and D2 represents a distance between a leading end of the downstream die lip and the substrate film.

Furthermore, according to the present invention, there are provided a polarizing plate, an optical element and an image display device, each having the aforesaid optical functional film.

Of a pair of die lips of the die coater in the present invention, by the upstream die lip is meant a die lip that is disposed on the upstream side in the traveling direction of a substrate film (or a side from which a pre-coated substrate film is fed), and by the downstream die lip is meant a die lip that is disposed on the downstream side in the traveling direction of the substrate film (or a side to which the substrate film is fed for the next step).

According to the present invention, by having the distance D2 between the leading end of the downstream die lip and the substrate film being 50 μm or greater, it is possible to prevent adhesion or solidification of polyimide at a leading end of the downstream die lip and efficiently prevent streaky coating unevenness in the traveling direction of the substrate film.

Furthermore, by providing stepped arrangement of 0<D1−D2≦200 μm to the leading ends of the pair of die lips, a coating liquid is applied through these leading ends of the die lips as it is enlarged or increased in volume towards the upstream side of the substrate film, so that the contacting state between the coating liquid and the substrate film is well maintained, and coating unevenness in the widthwise direction of the substrate film due to pulsations of the coating liquid or fluctuation in the traveling speed of the substrate film.

### ADVANTAGES OF THE INVENTION

According to the process for producing an optical functional film of the present invention, in combination with the above functions and advantages, a polyimide-containing coating liquid, which is easy to cause appearance defect when using a die coater in a conventional method, is possible to be applied with an even thickness while providing a thin layer, and thus a film having less appearance defect can be produced.

Also, the polarizing plate, the optical element and the image display device, of the present invention each can have an excellent performance with the aforesaid optical functional film.

### BRIEF DESCRIPTION OF THE DRAWINGS

FIG. 1 is a cross sectional view of a die lip as viewed in the traveling direction of a substrate film.

FIG. 2 is an enlarged view of a leading end of a die lip.

FIG. 3 is a view of an arrangement with an upstream die lip rounded or subjected to R-processing.

FIG. 4 is a view of an arrangement with a downstream die lip rounded or subjected to R-processing.

FIG. 5 is a view of an arrangement with both die lips rounded or subjected to R-processing.

FIG. 6 is a photograph of a test film obtained in Example 1.

FIG. 7 is a photograph of a test film obtained in Example 2.

FIG. 8 is a photograph of a test film obtained in Example 3.

FIG. 9 is a photograph of a test film obtained in Comparative Example 2.

FIG. 10 is a photograph of a test film obtained in Example 4.

FIG. 11 is a photograph of a test piece obtained in Example 5.

### DETAILED DESCRIPTION OF THE PREFERRED EMBODIMENT

The present invention provides a process for producing an optical functional film having a polyimide layer, which is characterized in that it includes an application step of applying a coating liquid containing polyimide and having a viscosity γ of 100<γ<3000 mPa·s on a substrate film by a die coater having an upstream die lip and a downstream die lip, thereby forming a polyimide layer on the substrate film, in which D2≧50 μm and 0<D1−D2≦200 μm are satisfied, in which D1 represents a distance between a leading end of the upstream die lip and the substrate film and D2 represents a distance between a leading end of the downstream die lip and the substrate film.

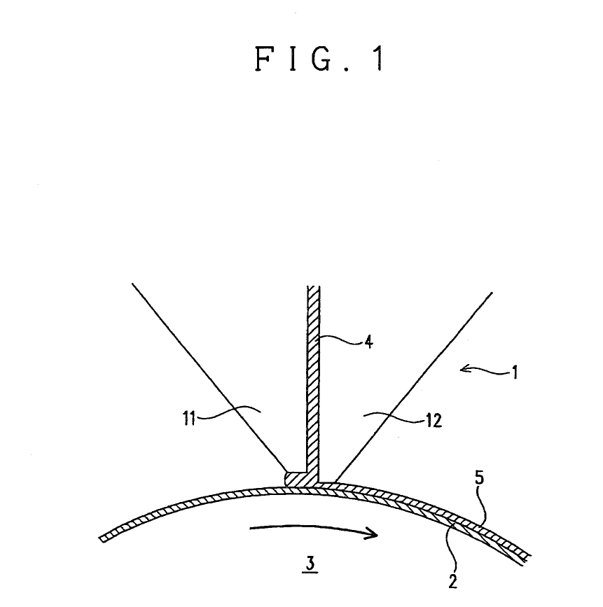

FIG. 1 illustrates one embodiment of a die coater for use in the process for producing an optical functional film of the present invention.

As illustrated in FIG. 1, a die coater 1 for use in this embodiment includes an upstream die lip 11 disposed on the upstream side in the traveling direction of a substrate film 2 and a downstream die lip 12 disposed on the downstream side in the traveling direction of the substrate film 2 so as to apply a coating liquid 4 onto the substrate film, which liquid is discharged through a clearance between the upstream die lip 11 and the downstream die lip 12.

The substrate film 2 is supported by a roll 3 from the side opposite to the die coater 1 and fed to the right hand side in the Figure by the rotation of the roll 3. Specifically, the coating liquid 4 discharged through the clearance between the upstream die lip 11 and the downstream die lip 12 is drawn ahead in the traveling direction of the substrate film 2 (towards the downstream side) by the contact with the substrate film 2, thus forming a coating layer.

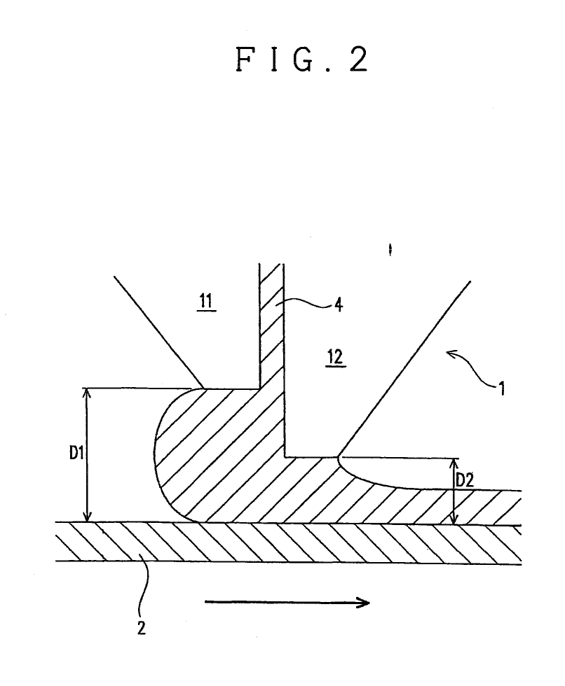

FIG. 2 is an enlarged view of leading ends of the die lips of FIG. 1. As illustrated in FIG. 2, when the distance between the leading end of the upstream die lip 11 and the substrate film 2 is represented by D1 and the distance between the leading end of the downstream die lip 12 and the substrate film 2 is represented by D2, the die coater 1 for use in the present invention is structured to satisfy: D2≧50 μm and 0<D1−D2≦200 μm.

When D2 (that is, the distance between the leading end of the downstream die lip 12 and the substrate film 2) is 50 μm or more, the coating liquid 4 having a sufficient thickness is fed through the leading end of the downstream die lip 12 in the traveling direction of the substrate film, so that the amount of polyimide contained in the coating liquid 4 can become uniform or the distribution of polyimide in a film surface can become uniform. When D2 is less than 50 μm, the amount of polyimide contained in a coating liquid applied on the substrate film becomes nonuniform in a film surface of the substrate film, which results in the occurrence of streaky coating unevenness on the produced optical functional film along the traveling direction of the substrate film.

No specific limitation is applied to the upper limit of D2, and it is possible to adjust the thickness according to the intended use of the formed polyimide layer, while it is usually about 300 μm.

D2 is set to be preferably 100≦D2≦250 μm and more preferably 150≦D2≦200 μm.

The leading end of the die coater used in the present invention is arranged to have a difference in height or stepped arrangement with the leading end of the upstream die lip 11 and the leading end of the downstream die lip 12 arranged to be 0<D1−D2≦200 μm.

The stepped arrangement allows the coating liquid 4 discharged through the clearance between the die lips to be applied onto the substrate film 2 and at the same time be enlarged or increased in volume towards the upstream die lip 11 (i.e., the upstream side of the substrate film) having a greater distance from the substrate film 2, so that the distance along which the coating liquid 4 at the leading ends of the die lips contacts the substrate film 2 is elongated, thus enabling them to be held in a good contacting state. The accumulated coating liquid 4 formed by the enlargement or increase in volume of the coating liquid 4 omits occurrence of coating unevenness in the widthwise direction of the substrate film due to pulsations of the coating liquid caused when the coating liquid 4 is discharged, or fluctuation in the traveling speed of the substrate film 2. Thus, appearance defect can be significantly reduced.

The stepped arrangement or difference in height mentioned above is preferably 0<D1−D2≦150 μm, more preferably 10≦D1−D2≦120 μm, and further preferably 30≦D1−D2≦100 μm.

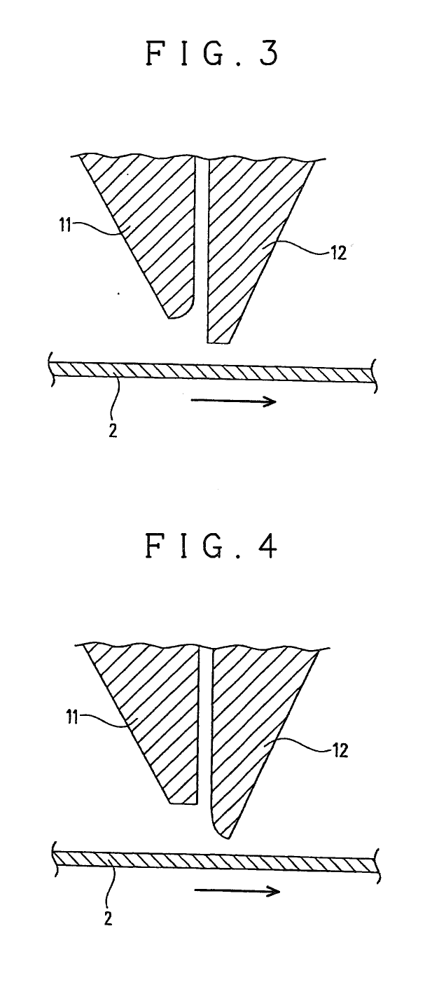

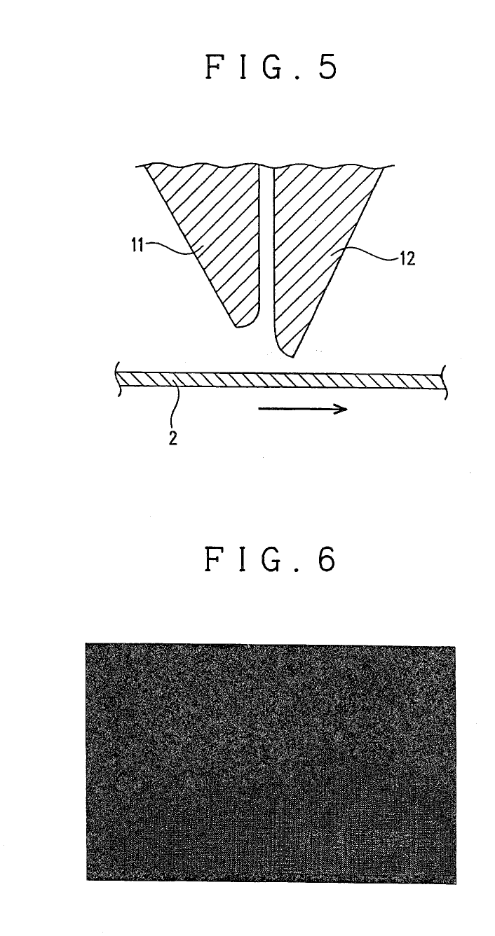

An inner leading end portion of at least one of the upstream die lip 11 and the downstream die lip 12 is preferably rounded (or also referred in this specification as being subjected to “R-processing”) with a curvature radius of 0.2 to 1.0 mm. FIG. 3 illustrates an arrangement with the leading end of the upstream die lip 11 R-processed, FIG. 4 illustrates an arrangement with the leading end of the downstream die lip 12 R-processed, and FIG. 5 illustrates an arrangement with both the leading ends R-processed.

With the arrangement having at least one of the upstream die lip and the downstream die lip having the inner leading end portion R-processed, it is possible to produce an advantage in that a coating liquid is discharged through the leading end portions of the die lips in a stabilized manner, thereby enabling a coating layer to have more uniform thickness.

Especially, when the downstream die lip is subjected to the R-processing, the flow of a coating liquid is further stabilized and thus has an advantage in that the thickness of the coating layer becomes more uniform. This advantage is easy to be exhibited when the viscosity γ of the coating liquid is great; when the viscosity γ exceeds 100 mPa·s, the advantage becomes significant; and when the viscosity γ exceeds 180 mPa·s, the advantage becomes more significant.

The width of a leading end of the die lips (distance between the die lips) is generally from 0.1 to 10.0 mm, preferably from 0.1 to 5.0 mm and more preferably from 0.5 to 3.0 mm.

When the width of the leading end of the die lips is not smaller than 0.1 mm, it is preferable from the point of view of the machining accuracy in preparing a die, and reduces the possibility that the leading end portions of the die lips are chipped off when in application of a coating liquid. When the width of the leading end of the die lips is not greater than 10.0 mm, the flow of a coating liquid at the leading ends of the die lips is stabilized, with the result that the obtained optical functional film has a better appearance.

The traveling speed of the substrate film relative to the die lips is generally 10 to 300 m/min, preferably 10 to 100 m/min, and more preferably 10 to 50 m/min.

By setting the traveling speed of the substrate film within a range of from 10 to 300 m/min, it is possible to produce an advantage that a coating liquid discharged through the leading ends of the die lips is well applied onto the substrate film and thus the polyimide layer has more uniform thickness.

The polyimide for use in the present invention is preferably of the type that has a high in-plane orientation and is soluble in organic solvent. Specifically, a polymer that includes a condensed polymer of 9,9-bis(aminoaryl)fluorene and an aromatic tetracarboxylic acid anhydride, having at least one repeat unit of the following formula (1), as disclosed in Japanese Patent Publication Tokuhyo 2000-511296, is appropriately usable.

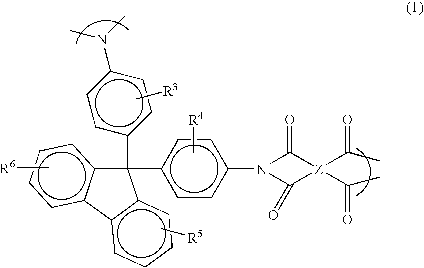

In the above formula (1), R³-R⁶ each are at least one substituent independently selected from the group consisting of hydrogen, halogen, phenyl or phenyl substituted with 1 to 4 halogen atoms or a C₁₋₁₀ (carbon numbers of 1-10) alkyl group, and a C₁₋₁₀ alkyl group, and R³-R⁶ each preferably are at least one substituent independently selected from the group consisting of halogen, phenyl or phenyl substituted with 1 to 4 halogen atoms or a C₁₋₁₀ alkyl group, and a C₁₋₁₀ alkyl group.

In the above formula (1), Z is for example a tetravalent aromatic group having 6 to 20 carbon atoms, and preferably a pyromellitic group, a polycyclic-aromatic group, derivatives of a polycyclic-aromatic group, or a group represented by the following formula (2).

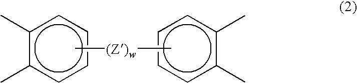

In the above formula (2), Z′ represents for example a covalent bond, a C(R⁷)₂ group, a CO group, an O atom, an S atom, an SO₂ group, an Si(C₂H₅)₂ group, or an NR⁸ group, and when there are plural Z's, they may be the same or different. w represents an integer from 1 to 10. R⁷ each are independently hydrogen or C(R⁹)₃. R⁸ is hydrogen, a C₁₋₂₀ alkyl group, or a C₆₋₂₀ aryl group, and when it is plural, they may be the same or different. R⁹ each are independently hydrogen, fluorine or chlorine.

An example of the polycyclic-aromatic group includes a tetravalent group derived from naphthalene, fluorene, benzofluoren or anthracene. Examples of the derivatives of the polycyclic-aromatic group include the polycyclic-aromatic group substituted with at least one selected from the group consisting of a C₁₋₁₀ alkyl group, its fluorinated derivatives, and halogens such as F and Cl.

Further examples of the polymer include homopolymer having a repeat unit represented by the following formula (3) or (4), or polyimide having a repeat unit represented by the following formula (5), as described Japanese Patent Publication Tokuhyo Hei-8-511812. A polyimide of the following formula (5) is a preferable form of a homopolymer of the formula (3).

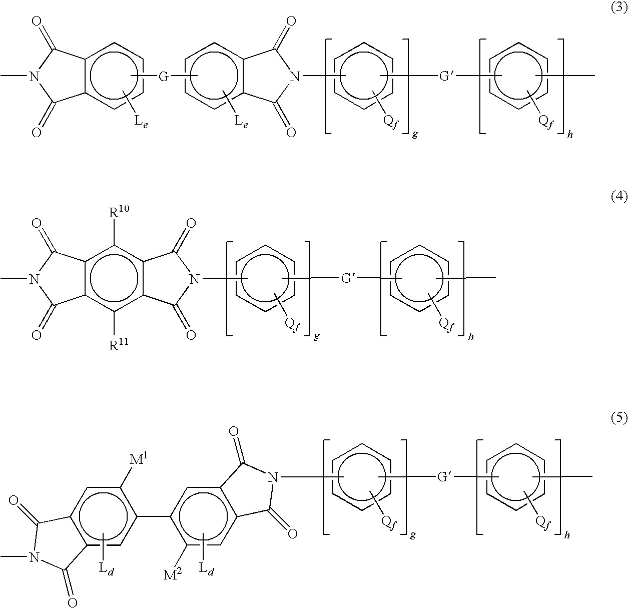

In the formulae (3) to (5), G and G′ each represent a covalent bond, or a group independently selected from the group consisting of, for example, a CH₂ group, a C(CH₃)₂ group, a C(CF₃)₂ group, a C(CX₃)₂ group (herein, X represent halogen), a CO group, an O atom, an S atom, an SO₂ group, an Si(CH₂CH₃)₂ group, and an N(CH₃) group. They may be the same or different.

In the formulae (3) and (5), L represents a substituent, and d and e each represent the number of the corresponding substituent. L represents for example halogen, a C₁₋₃ alkyl group, a halogenated C₁₋₃ alkyl group, a phenyl group, or a substituted phenyl group, and when there are plural Ls, they may be the same or different. Examples of the substituted phenyl group include a substituted phenyl group having at least one substituent selected from the group consisting of halogen, a C₁₋₃ alkyl group, and a halogenated C₁₋₃ alkyl group. Examples of the halogen include fluorine, chlorine, bromine and iodine. d represents an integer from 0 to 2, and e represents an integer from 0 to 3.

In the above formulae (3) to (5), Q represents a substituent and f represents the number of substitutions thereof. An example of Q includes an atom or group selected from the group consisting of hydrogen, halogen, an alkyl group, a substituted alkyl group, a nitro group, a cyano group, a thioalkyl group, an alkoxy group, an aryl group, a substituted aryl group, an alkyl ester group, and a substituted alkyl ester group. When there are plural Qs, they may be the same or different. Examples of the halogen include fluorine, chlorine, bromine and iodine. An example of the substituted alkyl group includes a halogenated alkyl group.

An example of the substituted aryl group includes a halogenated aryl group. In the formulae, f represents an integer from 0 to 4, and g and h respectively represent an integer from 0 to 3 and an integer from 1 to 3, in which g and h each are preferably greater than 1.

In the formula (4), R¹⁰ and R¹¹ each represent a group independently selected from the group consisting of hydrogen, halogen, a phenyl group, a substituted phenyl group, an alkyl group and a substituted alkyl group.

Among them, R¹⁰ and R¹¹ each are preferably a halogenated alkyl group independently selected therefrom.

In the formula (5), M¹ and M² may be the same or different, and examples of them include halogen, a C₁₋₃ alkyl group, a C₁₋₃ halogenated alkyl group, a phenyl group or a substituted phenyl group.

Examples of the halogen include fluorine, chlorine, bromine and iodine.

An example of the substituted phenyl group includes a substituted phenyl group having at least one substituent selected from the group consisting of halogen, a C₁₋₃ alkyl group, and a C₁₋₃ halogenated alkyl group.

An example of polyimide represented in the formula (3) includes the one represented by the following formula (6).

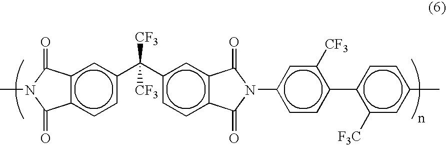

An example of the polyimide includes a copolymer prepared by appropriate copolymerization of dianhydride and diamine other than the aforesaid chemical architecture (repeat unit).

An example of the dianhydride includes aromatic tetracarboxilic dianhydride.

Examples of the aromatic tetracarboxilic dianhydride include pyromellitic dianhydride, benzophenon tetracarboxylic dianhydrade, naphthalene tetracarboxylic dianhydride, heterocyclic aromatic tetracarboxylic dianhydride, and 2,2′-substituted biphenyl tetracarboxylic dianhydride. Examples of the pyromellitic dianhydride include pyromellitic dianhydride, 3,6-diphenyl pyromellitic dianhydride, 3,6-bis(trifluoromethyl)pyromellitic dianhydride, 3,6-dibromopyromellitic dianhydride, and 3,6 dichloropyromellitic dianhydride. Examples of the benzophenone tetracarboxylic dianhydride include 3,3′,4,4′-benzophenone tetracarboxylic dianhydride, 2,3,3′,4′-benzophenone tetracarboxylic dianhydride and 2,2′,3,3′-benzophenone tetracarboxylic dianhydride. Examples of the naphthalene tetracarboxylic dianhydride include 2,3,6,7-naphthalene-tetracarboxylic dianhydride, 1,2,5,6-naphthalene-tetracarboxylic dianhydride, and 2,6-dichloro-naphthalene-1,4,5,8-tetracarboxylic dianhydride. Examples of the heterocyclic aromatic tetracarboxylic dianhydride include thiophene-2,3,4,5-tetracarboxylic dianhydride, pyrazine-2,3,5,6-tetracarboxylic dianhydride and pyridine-2,3,5,6-tetracarboxylic dianhydride.

Examples of the 2,2′-substituted biphenyl tetracarboxylic dianhydride include 2,2′-dibromo-4,4′,5,5′-biphenyl tetracarboxylic dianhydride, 2,2′-dichloro-4,4′,5,5′-biphenyl tetracarboxylic dianhydride and 2,2′-bis(trifluoromethyl)-4,4′,5,5′-biphenyl tetracarboxylic dianhydride.

Other examples of the aromatic tetracarboxylic dianhydride may include 3,3′,4,4′-biphenyl tetracarboxylic dianhydride, bis(2,3-dicarboxyphenyl)methane dianhydride, bis(2,5,6-trifluoro-3,4-dicarboxyphenyl)methane dianhydride, 2,2-bis(3,4-dicarboxyphenyl)-1,1,1,3,3,3-hexafluoropropane dianhydride, 4,4′(3,4-dicarboxyphenyl)-2,2-diphenylpropane dianhydride, bis(3,4-dicarboxyphenyl)ether dianhydride, 4,4′-oxydiphthalic dianhydride, bis(3,4-dicarboxyphenyl)sulfonic dianhydride (3,3′,4,4′-diphenylsulfone tetracarboxylic dianhydride), 4,4′-[4,4′-isopropylidene-di(p-phenyleneoxy)]bis(phthalic dianhydride), N,N-(3,4-dicarboxyphenyl)-N-methylamine dianhydride and bis(3,4-dicarboxyphenyl)diethylsilane dianhydride.

Among the above, the aromatic tetracarboxylic dianhydride preferably is 2,2′-substituted biphenyl tetracarboxylic dianhydride, more preferably is 2,2′-bis(trihalomethyl)-4,4′,5,5′-biphenyl tetracarboxylic dianhydride, and further preferably is 2,2′-bis(trifluoromethyl) 4,4′,5,5′-biphenyl tetracarboxylic dianhydride.

The aforesaid diamine may be, for example, aromatic diamine. Specific examples thereof include benzenediamine, diaminobenzophenone, naphthalenediamine, heterocyclic aromatic diamine and other aromatic diamines.

The benzenediamine may be, for example, diamine selected from the group consisting of benzenediamines such as o-, m- or p-phenylenediamine, 2,4-diaminotoluene, 1,4-diamino-2-methoxybenzene, 1,4-diamino-2-phenylbenzene and 1,3-diamino-4-chlorobenzene. Examples of the diaminobenzophenone include 2,2′-diaminobenzophenone and 3,3′-diaminobenzophenone. The naphthalenediamine may be, for example, 1,8-diaminonaphthalene or 1,5-diaminonaphthalene. Examples of the heterocyclic aromatic diamine include 2,6-diaminopyridine, 2,4-diaminopyridine and 2,4-diamino-S-triazine.

Further, other than the above, the aromatic diamine may be 4,4′-diaminobiphenyl, 4,4′-diaminodiphenyl methane, 4,4′-(9-fluorenylidene)-dianiline, 2,2′-bis(trifluoromethyl)-4,4′-diaminobiphenyl, 3,3′-dichloro-4,4′-diaminodiphenyl methane, 2,2′-dichloro-4,4′-diaminobiphenyl, 2,2′,5,5′-tetrachlorobenzidine, 2,2-bis(4-aminophenoxyphenyl)propane, 2,2-bis(4-aminophenyl)propane, 2,2-bis(4-aminophenyl)-1,1,1,3,3,3-hexafluoropropane, 4,4′ diamino diphenyl ether, 3,4′-diamino diphenyl ether, 1,3-bis(3-aminophenoxy)benzene, 1,3-bis(4-aminophenoxy)benzene, 1,4-bis(4-aminophenoxy)benzene, 4,4′-bis(4-aminophenoxy)biphenyl, 4,4′-bis(3-aminophenoxy)biphenyl, 2,2-bis [4-(4-aminophenoxy)phenyl]propane, 2,2-bis [4-(4-aminophenoxy)phenyl]-1,1,1,3,3,3,-hexafluoropropane, 4,4′-diamino diphenyl thioether or 4,4′-diaminodiphenylsulfone.

Meanwhile, as a solvent for dissolving the polyimide, methyl isobutyl ketone (MIBK) is preferably added to the coating liquid. By the use of MIBK, it is possible to satisfactorily dissolve polyimide even when the concentration of the polyimide in the coating liquid has been increased, so that the coating liquid can be smoothly discharged through the leading ends of the die lips and a polyimide layer having a uniform concentration distribution can be formed on the substrate film.

Since the evaporation rate of MIBK is relatively slow compared with other solvents capable of dissolving polyimide, a coating liquid discharged through the leading ends of the die lips is slowly and gradually dried. Whereby, polyimide can be prevented from adhering to or solidifying at the leading end of the downstream die lip, and streaky coating unevenness along the flow direction of the substrate film can be prevented from occurring.

MIBK has excellent solvent power for polyimide, while has less solvent power for triacetyl cellulose (hereinafter referred also to “TAC”) frequently used as a substrate film, so that when a substrate film made of TAC is used, there is an advantage to be able to prevent appearance defect due to erosion of the substrate film.

The density of polyimide in a coating liquid is preferably from 5 to 20% by weight, more preferably from 7 to 15% by weight and further preferably from 10 to 13.5% by weight.

By having the concentration of polyimide within these ranges, the viscosity of the coating liquid becomes a preferable value, so that when D2 (the distance between the downstream die lip and the substrate film) is determined in the manner mentioned above, a polyimide layer having a uniform concentration distribution can be formed on the substrate film 2.

A specific viscosity γ of the coating liquid is preferably 100<γ≦3000 mPa·s, more preferably 100<γ<1000 mPa·s, and especially preferably 180<γ<850 mPa·s.

The viscosity of the coating liquid is measured by the method described in Examples.

Additives may be appropriately added in the coating liquid according to needs and circumstances. Although no particular limitation is intended, as additives, it is possible to use a UV absorber, a deterioration preventing agent (e.g., an antioxidant, a peroxide decomposing agent, a radical inhibitor, a metal deactivator, an acid capturing agent and an amine), a plasticizer and an antistatic agent, as well as additives for achieving an optional purpose, such as securing adhesiveness relative to the substrate film.

A coating layer applied on the substrate film 2 by the application step turns to be a polyimide-containing layer (in this specification, sometimes simply referred to “polyimide layer”) after the solvent has been vaporized. A thickness d of the dried polyimide layer is preferably d≦30 μm, more preferably d≦10 μm and especially preferably d≦5 μm.

When the thickness d of the polyimide layer exceeds 30 μm, appearance defect may be caused due to drying unevenness, blisters and the like in a drying step.

The thickness of the polyimide layer is adjustable by the adjustment of the traveling speed of the substrate film or the feeding rate of the coating liquid.

Meanwhile, as an example of the substrate film for use in the present invention, it can be cited a film made of a transparent polymer, such as polyester polymers, such as polyethylene terephthalate and polyethylene naphthalate; cellulose polymers, such as cellulose diacetate and cellulose triacetate; polycarbonate polymers; and acrylic polymers, such as polymethyl methacrylate.

It is also possible to cite a film made of a transparent polymer, such as styrene polymers, such as polystyrene and acrylonitrile-styrene copolymer; olefin polymers, such as polyethylene, polypropylene, polyolefin having a cyclo or norbornene structure and ethylene-propylene copolymer; vinyl chloride polymers; and amide polymers, such as Nylon and aromatic polyamide.

It can be also cited a film made of a transparent polymer, such as imide polymers; sulfone polymers; polyether-sulfone polymers, polyether-ether-ketone polymers; polyphenylene sulfide polymers; vinyl alcohol polymers; vinylidene chloride polymers; vinyl butyral polymers; allylate polymers; polyoxymethylene polymers; epoxy polymers; and blends of these polymers. Especially in optical property, a film having small birefringence is suitably used.

Among them, as the substrate film, a film made of a cellulose polymer, such as triacetylcellulose, is preferable and a triacetylcellulose film is especially preferable from the view point of light polarizing property, endurance and the like.

In the present invention, by having the distance D2 between the leading end of the downstream die lip and the substrate film being 50 μm or greater, the coating liquid has an increased thickness and thus the time, during which the substrate film contacts the solvent, tends to extend; and when using a triacetylcellulose film as a substrate film while using a commonly used solvent such as ethyl acetate, there is a fear that the triacetylcellulose film is adversely influenced. However, when using methyl isobutyl ketone as a solvent of a coating liquid, it is possible to prevent adverse influences, such as dissolution of the triacetylcellulose film, and thus prevent the occurrence of appearance defect.

The thickness of the substrate film can be appropriately determined according to needs and circumstances, while it is generally about from 10 to 500 μm, preferably from 20 to 300 μm and more preferably from 30 to 200 μm from the view point of workability, such as strength and handling property, and thin film characteristics.

Any optional resin layer may be formed on the coated surface of the substrate film so that a coating liquid can be applied therethrough. As the resin layer, it can be cited an adhesive layer that is formed by preferably directly applying polyurethane-based resin solution (also referred as dissolved liquid or dispersed liquid) onto the substrate film and drying the same.

By forming an adhesive layer formed by the application of polyurethane-based resin solution, it is possible to alleviate the influence of the microscopic irregular surface configuration or surface undulation of the substrate film onto the retardation value.

Examples of the polyurethane-based resin include polyester-based polyurethane (modified polyester urethane, water-dispersible polyester urethane, solvent-based polyester urethane), polyether-based urethane and polycarbonate-based urethane. These polyurethane-based resins may be of a self-emulsifying type or nonself-emulsifying type. Of these types of polyurethane, preferable is polyester-based polyurethane.

These polyurethane-based resins are generally produced from polyol and polyisocyanate.

Examples of the polyol include polyester polyol, polyether polyol or other types of polyol.

The polyester polyol is a reaction product of fatty acid and polyol. Examples of the fatty acid include a hydroxy long chain fatty acid of such as ricinolic acid, oxycaproic acid, oxycapric acid, oxyundecanoic acid, oxylinolenic acid, oxystearic acid or oxyhexadecenoic acid. Examples of polyol to be reacted with a fatty acid include: glycol such as ethylene glycol, propylene glycol, butylene glycol, hexamethylene glycol and diethylene glycol; a trifunctional polyol such as glycerin, trimethylolpropane and triethanolamine; a tetrafunctional polyol such as diglycerin and pentaerythritol; hexafunctional polyol such as sorbitol; octafunctional polyol such as sugar; an addition polymer of alkylene oxide, which corresponds to these polyols, and aliphatic, alicyclic or aromatic amine; and an addition polymer of the aforesaid alkylene oxide and polyamide polyamine.

Examples of the polyether polyol include an addition polymer of any one of dihydric alcohol and trihydric or higher polyhydric alcohol, and alkylene oxide, in which examples of the dihydric alcohol include ethylene glycol, diethylene glycol, propylene glycol, dipropylene glycol, 1,3-butandiol, 1,4-butandiol, 4,4′-dihydroxyphenylpropane, and 4,4′-dihydroxyphenylmethane; examples of the trihydric or higher polyhydric alcohol include glycerin, and 1,1,1-trimethylolpropane, 1,2,5-hexanetriole and pentaerythritol; and examples of the alkylene oxide include ethylene oxide, propylene oxide, butylene oxide, and α-olefin oxide.

Examples of the other polyols include polyols whose main chain is composed of carbon-carbon bond, for example, acrylic polyol, polybutadiene polyol, polyisoprene polyol, hydrogenated polybutadiene polyol, polyols obtained by graft polymerization of AN (acrylonitrile) or SM (styrene monomer) onto those polyols whose main chain is composed of carbon-carbon bond, polycarbonate polyol, and PTMG (polytetramethylene glycol).

Examples of the polyisocyanate include aromatic polyisocyanate, aliphatic polyisocyanate, and alicyclic polyisocyanate. Examples of the aromatic polyisocyanate include diphenylmethane diisocyanate (MDI), polymethylene polyphenylene polyisocyanate (crude MDI), tolylene diisocyanate (TDI), polytrilen polyisocyanate (crude TDI), xylendiisocyanate (XDI), and naphthalenediisocyanate (NDI). An example of the aliphatic polyisocyanate includes hexamethylenediisocyanate (HDI). An example of the alicyclic polyisocyanate includes isophoronediisocyanate (IPDI). Examples of the aforesaid polyisocyanate further include polyisocyanate being the aforesaid polyisocyanate modified with carbodiimide (carbodiimide-modified polyisocyanate), isocyanurate-modified polyisocyanate, and urethaneprepolymer (e.g., a reaction product between polyol and excess polyisocyanate having an isocyanate group in end terminals thereof). These may be used alone or in mixture.

Examples of solvents of the solution (also referred as the dissolved liquid and the dispersed liquid), include water, a variety of organic solvents or mixed solvents thereof. Examples of the organic solvents include methylethylketone, isopropilalcohol, toluene, N-methylpyrrolidone (NMP), and methylisobutylketone. The concentration of a polyurethane-based resin in a solution containing the polyurethane-based resin is appropriately determined, but is generally within a range of from 5 to 50% by weight and preferably from 10 to 40% by weight in view of the coating condition onto a substrate (possibility of having foreign matter mixed therein or uneven coating or streaky coating unevenness). When less than 5% by weight, the solution has an excessively low viscosity and is difficult to be applied to a given film thickness by one stroke. When more than 50% by weight, it has an excessively high viscosity and therefore is likely to cause a fault such as a roughly coated surface.

The thickness of the adhesive layer is preferably within a range of from 100 nm to 10 μm. When smaller than 100 nm, it is unlikely to produce a sufficient adhesive power. When greater than 10 μm, a problem may arise in producing thin-profile or light-weight products. In addition, when greater than 10 μm, the adhesive layer having such an excessive thickness itself may have birefringent characteristics, which may pose the difficulty in producing an optical functional film having desirable birefringent characteristics.

It is not necessary to limit an application technique of applying the polyurethane-based resin-containing solution onto the substrate film to a specific technique. For example, it is possible to employ spin coating, roll coating, die coating, blade coating or any other conventional coating techniques. The adhesive layer can be formed by applying the solution onto the substrate film to have a given thickness and then drying the same, following these techniques.

The temperature for drying may be appropriately determined according to the kind of solvent or the like, but is usually within a range of from 80 to 200° C., and preferably within a range of from 100 to 150° C. The drying operation may be made at a constant temperature or alternatively made stepwisely while increasing the temperature.

The time for drying operation is generally within a range of from 5 to 30 minutes and preferably within a range of from 10 to 20 minutes. When shorter than 5 minutes, a great amount of solvent may be left, which causes a problem in product reliability. When longer than 30 minutes, insufficient industrial productivity may be caused.

Furthermore, it is possible to produce a desirable optical functional film by combining a drying step, a stretching step, a laminating step for laminating a different resin layer, or a variety of surface treatment steps, according to the intended use of the optical functional film, after the formation of the coating layer on the substrate film.

The optical functional film produced by the process for producing the optical functional film of the present invention has much less bright spots due to repellent action on the coated surface, and much less thickness unevenness in the traveling direction of the substrate film (that is, the longitudinal direction) or in the widthwise direction. Thus, appearance defect is greatly reduced in the optical functional film.

A polarizing plate of the present invention is made up of a laminate of the thus prepared optical functional film and a polarizer, in which no limitation is intended to other components. A retardation film may not be directly laminated with a polarizer and may be laminated together via a different material.

The polarizer is not necessarily limited to a specific one, and any one prepared by a known method, which involves, for example, allowing various types of films each to absorb a dichromatic substance, such as iodine or a dichromatic dye, thereby dying the film, and stretching, crosslinking and drying the film. Of them, it is preferable to use a film that can transmit linearly polarized light when natural light is made incident thereon and a film that has excellent light transmittance and polarizing degree. Examples of the variety of films in which the dichroic substance is to be adsorbed include hydrophilic polymer films, such as polyvinyl alcohol (PVA)-based films, partially-formalized PVA-based films, partially-saponified films based on ethylene-vinyl acetate copolymer and cellulose-based films. In addition to these films, polyvinyl chloride based oriented films, such as dehydrated PVA and dehydrochlorinated polyvinyl chloride, can be used. Of them, the PVA-based film is preferable. The thickness of the polarizer generally ranges from 1 to 80 μm without limitation thereto.

As a specific example of the polarizing plate of the present invention, it can be cited a polarizing plate made up of a laminate of the thus prepared optical functional film of the present invention (e.g., retardation film), a polarizer and a transparent protection film.

The method of laminating the optical functional film with the polarizing plate (or polarizer) is not necessarily limited to a specific method and any conventional method may be employed. In general, it is possible to use any sticking agent or adhesive, and the type of each of them may be appropriately determined according to the material of the retardation film or the like. Examples of the adhesive include acrylic, vinyl alcohol-based, silicone-based, polyester-based, polyurethane-based, and polyether-based polymer pressure sensitive adhesives, and rubber-based pressure-sensitive adhesives. It is also possible to use an adhesive made of, for example, an aqueous crosslinking agent of a vinyl alcohol-based polymer, such as glutaric aldehyde, melamine or oxalic acid. As these adhesives or sticking agents, it is preferable to use, for example, those that are unlikely to be peeled even if they are influenced by temperature or heat, and are excellent in light transmittance and polarizing degree. Specifically, when the polarizer is a PVA-based film, a PVA-based adhesive is preferable in light of stability of adhering treatment and the like. These adhesive and sticking agent may be applied onto a surface of the polarizer, the transparent protection film or the like, or a layer of a tape or a sheet formed of the adhesive or sticking agent may be arranged on the surface thereof.

An image display device of the present invention has the optical functional film disposed on a display screen thereof. As the image display device, it is possible to employ an appropriate image display device, such as a transmissive or reflective liquid-crystal device, and an organic electroluminescence device.

### EXAMPLES

Examples of the present invention will be cited herein below without intention to limit the present invention thereto. Various characteristics were measured by the following methods.

(Measuring Method of Viscosity)

The viscosity was measured at a liquid temperature of 23° C. and a shear rate of 10 [l/s], using a rheometer: RS-1 manufactured by Haake Co.

(Measuring Method of Moving Speed of a Substrate Film)

The running speed of the substrate film was measured by using a laser Doppler system marketed under the trade name of “Laser Speed System MODEL LS200” manufactured by Kanomax Japan, Inc.

(Measuring Method of Coat Thickness)

Measuring was made by using a dial gauge manufactured by Ozaki MFG. Co., Ltd.

### Example 1

10% by weight of polyimide (the aforesaid formula (6), weight-average molecular weight Mw=140,000) is dissolved in methyl isobutyl ketone to prepare a polyimide solution having a viscosity of 200 mPa·sec. The polyimide solution is used as a coating liquid and this coating liquid is applied onto a polyethylene terephthalate film as a substrate film (thickness: 75 μm) that is kept moving at a moving speed of 20 m/min, by using a slit die coater (D2=100 μm, D1−D2=50 μm, die lip leading end width: 0.8 mm) having the structure as illustrated in FIG. 2, and after application, it was dried at 120° C. for 3 minutes. Thus, a test film with a polyimide layer having a thickness of 3 μm was produced.

FIG. 6 is a photograph of a top view of the test film produced in Example 1. As illustrated in FIG. 6, it has been found that the produced test film as a whole has no interference unevenness observable with eyes and has a very excellent appearance, although a gentle streaky interference unevenness resulting from the thickness unevenness of the polyimide layer is partly and slightly caused.

### Example 2

A test film with a polyimide layer having a thickness of 3 μm was produced in the same manner as in Example 1, except that a slit die coater having D2=100 μm, D1−D2=30 μm and a die lip leading end width of 0.8 mm is used.

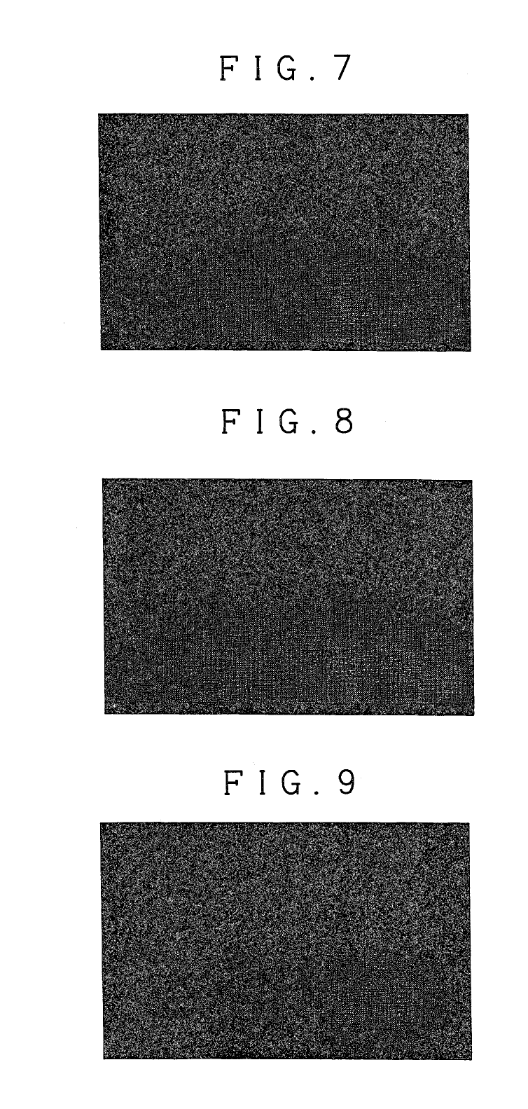

FIG. 7 is a photograph of a top view of the test film produced in Example 2. As illustrated in FIG. 7, it has been found that interference unevenness resulting from the thickness unevenness of the polyimide layer is almost not found in the produced test film, and a film having a good appearance is produced.

### Example 3

A test film with a polyimide layer having a thickness of 3 μm was produced in the same manner as in Example 1, except that a slit die coater having D2=60 μm, D1−D2=10 μm and a die lip leading end width of 0.8 mm is used.

FIG. 8 is a photograph of a top view of the test film produced in Example 3. As illustrated in FIG. 8, it has been found that the produced test film as a whole has no interference unevenness observable with eyes and has a very excellent appearance, although a gentle streaky interference unevenness resulting from the thickness unevenness of the polyimide layer is partly and slightly caused.

### Comparative Example 1

An attempt was made to produce a test film in the same manner as in Example 1, except that a slit die coater having D2=100 μm, D1−D2=−20 μm and a die lip leading end width of 0.8 mm is used.

However, a coating liquid discharged through the leading ends of the die lips could not be applied as a coating liquid onto a substrate film.

### Comparative Example 2

A test film with a polyimide layer having a thickness of 3 μm was produced in the same manner as in Example 1, except that a slit die coater having D2=30 μm, D1−D2=30 μm and a die lip leading end width of 0.8 mm is used.

FIG. 9 is a photograph of a top view of the test film produced in Comparative Example 2. As illustrated in FIG. 9, it has been found that interference unevenness is caused in the polyimide layer of the thus obtained test film in the widthwise direction of the substrate film (in the longitudinal direction in FIG. 9), and appearance defect is caused.

### Example 4

A test film with a polyimide layer having a thickness of 3 μm was produced in the same manner as in Example 1, except that a triacetylcellulose film (thickness: 80 μm) is used as a substrate film.

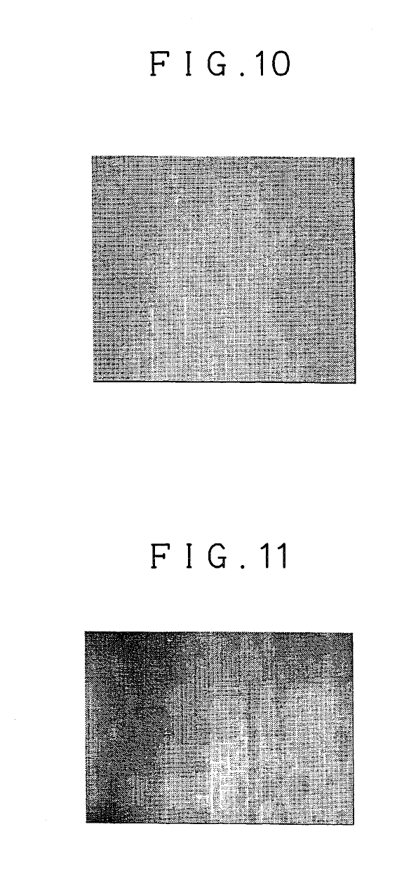

FIG. 10 is a photograph of a top view of the test film produced in Example 4. As illustrated in FIG. 10, it has been found that the produced test film has no interference unevenness observable with eyes in some areas and has a very excellent appearance, although a gentle streaky interference unevenness resulting from the thickness unevenness of the polyimide layer is partly and slightly caused in the other areas.

### Example 5

A test film with a polyimide layer having a thickness of 3 μm was produced in the same manner as in Example 4, except that a coating film using ethyl acetate as a solvent is used.

FIG. 11 is a photograph of a top view of the test film produced in Example 5. In the test film produced in Example 5, appearance defects were reduced compared with a conventional film using ethyl acetate. Specifically, due to dissolution of triacetylcellulose film as a substrate film in ethyl acetate, streaky interference unevenness as illustrated in FIG. 11 is caused. However, it has been found that the film has a good appearance with no practical problem.

### Example 6

A polyimide solution having a viscosity of 110 mPa·sec was prepared by dissolving 10.7% by weight of polyimide (the aforesaid formula (6), weight-average molecular weight Mw=102,000). A test film with a polyimide layer having a thickness of 3 μm was produced in the same manner as in Example 1, except that this polyimide solution is used as a coating liquid.

It has been found that although the produced test film has somewhat streaky interference unevenness caused in some areas along the traveling direction of a substrate film, it has a good appearance with no practical problem, and has an excellent appearance with only gentle interference unevenness found in the other areas.

### Example 7

A polyimide solution having a viscosity of 267 mPa·sec was prepared by dissolving 12.5% by weight of polyimide (the aforesaid formula (6), weight-average molecular weight Mw=102,000). A test film with a polyimide layer having a thickness of 3 μm was produced in the same manner as in Example 6, except that this polyimide solution is used as a coating liquid.

It has been found that the produced test film has a remarkably excellent appearance with no interference unevenness.

### Example 8

A polyimide solution having a viscosity of 593 mPa·sec was prepared by dissolving 15.2% by weight of polyimide (the aforesaid formula (6), weight-average molecular weight Mw=102,000). A test film with a polyimide layer having a thickness of 3 μm was produced in the same manner as in Example 6, except that this polyimide solution is used as a coating liquid.

It has been found that although the produced test film has somewhat interference unevenness caused along the traveling direction of a substrate film, it has a good appearance with no practical problem.

### Example 9

A polyimide solution having a viscosity of 104 mPa·sec was prepared by dissolving 8.4% by weight of polyimide (the aforesaid formula (6), weight-average molecular weight Mw=145,000). A test film with a polyimide layer having a thickness of 3 μm was produced in the same manner as in Example 1, except that this polyimide solution is used as a coating liquid.

It has been found that although the produced test film has somewhat streaky interference unevenness caused along the traveling direction of a substrate film, it has a good appearance with no practical problem.

### Example 10

A polyimide solution having a viscosity of 320 mPa·sec was prepared by dissolving 11.1% by weight of polyimide (the aforesaid formula (6), weight-average molecular weight Mw=145,000). A test film with a polyimide layer having a thickness of 3 μm was produced in the same manner as in Example 9, except that this polyimide solution is used as a coating liquid.

It has been found that the produced test film has a remarkably excellent appearance with no interference unevenness.

### Example 11

A polyimide solution having a viscosity of 829 mPa·sec was prepared by dissolving 12.9% by weight of polyimide (the aforesaid formula (6), weight-average molecular weight Mw=145,000). A test film with a polyimide layer having a thickness of 3 μm was produced in the same manner as in Example 9, except that this polyimide solution is used as a coating liquid.

It has been found that the produced test film has a remarkably excellent appearance with no interference unevenness.

### Example 12

A polyimide solution having a viscosity of 2051 mPa·sec was prepared by dissolving 15.2% by weight of polyimide (the aforesaid formula (6), weight-average molecular weight Mw=145,000). A test film with a polyimide layer having a thickness of 3 μm was produced in the same manner as in Example 9, except that this polyimide solution is used as a coating liquid.

It has been found that although the produced test film has somewhat streaky interference unevenness caused along the traveling direction of a substrate film, it has a good appearance with no practical problem.

### Example 13

A test film with a polyimide layer having a thickness of 3 μm was produced in the same manner as in Example 1, except that a slit die coater having D2=100 μm, D1−D2=100 μm and a distance between the die lips of 0.8 mm, and having an inner leading end of the downstream die lip being R-processed with a curvature radius of 0.5 mm is used.

It has been found that the produced test film has an excellent appearance with only gentle streaky interference unevenness caused along the traveling direction of a substrate film.

### Comparative Example 3

An attempt was made to produce a test film with a polyimide layer having a thickness of 3 μm in the same manner as in Example 1, except that a slit die coater having D2=100 μm, D1−D2=−210 μm and a distance between the die lips of 0.8 mm, and having an inner leading end of the downstream die lip being R-processed with a curvature radius of 0.5 mm is used.

However, a coating liquid discharged through the leading ends of the die lips could not be applied as a coating liquid onto a substrate film.

### Comparative Example 4

A test film with a polyimide layer having a thickness of 3 μm was produced in the same manner as in Example 1, except that a slit die coater having D2=100 μm, D1−D2=0 μm and a distance between the die lips of 0.8 mm, and having an inner leading end of the downstream die lip being R-processed with a curvature radius of 0.5 mm is used.

It has been found that although the produced test film has portions having a good appearance with no practical problem, it has portions with significant streaky interference unevenness and therefore the appearance is not so good.

### Example 14

A test film with a polyimide layer having a thickness of 3 μm was produced in the same manner as in Example 1, except that a slit die coater having D2=100 μm, D1−D2=50 μm and a distance between the die lips of 0.8 mm, and having an inner leading end of the downstream die lip being R-processed with a curvature radius of 0.5 mm is used.

It has been found that the produced test film has no streaky interference unevenness observable with eyes and has a remarkably excellent appearance. This film remains excellent even when compared with the appearance of a test film produced by a die lip of such as Example 1 which is not R-processed.

### Example 15

A test film with a polyimide layer having a thickness of 3 μm was produced in the same manner as in Example 2, except that a slit die coater having D2=100 μm, D1−D2=30 μm and a distance between the die lips of 0.8 mm, and having an inner leading end of the downstream die lip being R-processed with a curvature radius of 0.5 mm is used.

It has been found that the produced test film has no streaky interference unevenness observable with eyes and has a remarkably excellent appearance. This film remains excellent even when compared with the appearance of a test film produced by a die lip of such as Example 2 which is not R-processed.

### Example 16

A test film with a polyimide layer having a thickness of 3 μm was produced in the same manner as in Example 3, except that a slit die coater having D2=60 μm, D1−D2=10 μm and a distance between the die lips of 0.8 mm, and having an inner leading end of the downstream die lip being R-processed with a curvature radius of 0.5 mm is used.

It has been found that although gentle streaky interference unevenness is found in some portions of the produced test film, no interference unevenness observable with eyes is found in the other portions and thus a remarkably excellent appearance is obtained. This film remains excellent even when compared with the appearance of a test film produced by a die lip of such as Example 3 which is not R-processed.

### Comparative Example 5

An attempt was made to produce a test film with a polyimide layer having a thickness of 3 μm in the same manner as in Example 1, except that a slit die coater having D2=100 μm, D1−D2=−20 μm and a distance between the die lips of 0.8 mm, and having an inner leading end of the downstream die lip being R-processed with a curvature radius of 0.5 mm is used. However, a coating liquid discharged through the leading ends of the die lips could not be applied as a coating liquid onto a substrate film.

### Comparative Example 6

A test film with a polyimide layer having a thickness of 3 μm was produced in the same manner as in Example 1, except that a slit die coater having D2=30 μm, D1−D2=30 μm and a distance between the die lips of 0.8 mm, and having an inner leading end of the downstream die lip being R-processed with a curvature radius of 0.5 mm is used.

It has been found that the produced test film has an extremely poor appearance, in which there are clearly found thin streaky interference unevenness in the entire area of the produced test film and thick streaky interference unevenness in some portions of the same.

### Example 17

A test film with a polyimide layer having a thickness of 3 μm was produced in the same manner as in Example 4, except that a slit die coater having D2=100 μm, D1−D2=50 μm and a distance between the die lips of 0.8 mm, and having an inner leading end of the downstream die lip being R-processed with a curvature radius of 0.5 mm is used, and a triacetylcellulose film (thickness: 75 μm) is used as a substrate film.

It has been found that the produced test film has no streaky interference unevenness observable with eyes and thus has a remarkably excellent appearance. This film remains excellent even when compared with the appearance of a test film produced by a die lip of such as Example 4 which is not R-processed.

### Example 18

A test film with a polyimide layer having a thickness of 3 μm was produced in the same manner as in Example 1, except that ethyl acetate is used as solvent in place of methyl isobutyl ketone, and a slit die coater having D2=100 μm, D1−D2=50 μm and a distance between the die lips of 0.8 mm, and having an inner leading end of the downstream die lip being R-processed with a curvature radius of 0.5 mm is used, and a triacetylcellulose film (thickness: 75 μm) is used as a substrate film.

It has been found that although the produced test film has somewhat streaky interference unevenness, it has a good appearance with no practical problem.

### Example 19

A polyimide solution having a viscosity of 110 mPa·sec was prepared by dissolving 10.7% by weight of polyimide (the aforesaid formula (6), weight-average molecular weight Mw=102,000). A test film with a polyimide layer having a thickness of 3 μm was produced in the same manner as in Example 6, except that this polyimide solution is used as a coating liquid, and a slit die coater having D2=100 μm, D1−D2=50 μm and a distance between the die lips of 0.8 mm, and having an inner leading end of the downstream die lip being R-processed with a curvature radius of 0.5 mm is used.

It has been found that the produced test film has a good appearance with only gentle streaky interference unevenness slightly caused along the traveling direction of a substrate film. This film remains excellent even when compared with the appearance of a test film produced by a die lip of such as Example 6 which is not R-processed.

### Example 20

A polyimide solution having a viscosity of 267 mPa·sec was prepared by dissolving 12.5% by weight of polyimide (the aforesaid formula (6), weight-average molecular weight Mw=102,000). A test film with a polyimide layer having a thickness of 3 μm was produced in the same manner as in Example 7, except that this polyimide solution is used as a coating liquid, and a slit die coater having D2=100 μm, D1−D2=50 μm and a distance between the die lips of 0.8 mm, and having an inner leading end of the downstream die lip being R-processed with a curvature radius of 0.5 mm is used.

It has been found that the produced test film has no streaky interference unevenness observable with eyes and has a remarkably excellent appearance. This film remains excellent even when compared with the appearance of a test film produced by a die lip of such as Example 7 which is not R-processed.

### Example 21

A polyimide solution having a viscosity of 593 mPa·sec was prepared by dissolving 15.2% by weight of polyimide (the aforesaid formula (6), weight-average molecular weight Mw=102,000). A test film with a polyimide layer having a thickness of 3 μm was produced in the same manner as in Example 8, except that this polyimide solution is used as a coating liquid, and a slit die coater having D2=100 μm, D1−D2=50 μm and a distance between the die lips of 0.8 mm, and having an inner leading end of the downstream die lip being R-processed with a curvature radius of 0.5 mm is used.

It has been found that the produced test film has an excellent appearance with only gentle streaky interference unevenness slightly caused along the traveling direction of a substrate film. This film remains excellent even when compared with the appearance of a test film produced by a die lip of such as Example 8 which is not R-processed.

### Example 22

A polyimide solution having a viscosity of 104 mPa·sec was prepared by dissolving 8.4% by weight of polyimide (the aforesaid formula (6), weight-average molecular weight Mw=145,000). A test film with a polyimide layer having a thickness of 3 μm was produced in the same manner as in Example 9, except that this polyimide solution is used as a coating liquid, and a slit die coater having D2=100 μm, D1−D2=50 μm and a distance between the die lips of 0.8 mm, and having an inner leading end of the downstream die lip being R-processed with a curvature radius of 0.5 mm is used.

It has been found that although the produced test film has somewhat streaky interference unevenness in some portions, it has a good appearance with only gentle interference unevenness found in the other portions. This film remains excellent even when compared with the appearance of a test film produced by a die lip of such as Example 9 which is not R-processed.

### Example 23

A polyimide solution having a viscosity of 320 mPa·sec was prepared by dissolving 11.1% by weight of polyimide (the aforesaid formula (6), weight-average molecular weight Mw=145,000). A test film with a polyimide layer having a thickness of 3 μm was produced in the same manner as in Example 10, except that this polyimide solution is used as a coating liquid, and a slit die coater having D2=100 μm, D1−D2=50 μm and a distance between the die lips of 0.8 mm, and having an inner leading end of the downstream die lip being R-processed with a curvature radius of 0.5 mm is used.

It has been found that the produced test film has no streaky interference unevenness observable with eyes and has a remarkably excellent appearance. This film remains excellent even when compared with the appearance of a test film produced by a die lip of such as Example 10 which is not R-processed.

### Example 24

A polyimide solution having a viscosity of 829 mPa·sec was prepared by dissolving 12.9% by weight of polyimide (the aforesaid formula (6), weight-average molecular weight Mw=145,000). A test film with a polyimide layer having a thickness of 3 μm was produced in the same manner as in Example 11, except that this polyimide solution is used as a coating liquid, and a slit die coater having D2=100 μm, D1−D2=50 μm and a distance between the die lips of 0.8 mm, and having an inner leading end of the downstream die lip being R-processed with a curvature radius of 0.5 mm is used.

It has been found that the produced test film has no streaky interference unevenness observable with eyes and has a remarkably excellent appearance. This film remains excellent even when compared with the appearance of a test film produced by a die lip of such as Example 11 which is not R-processed.

### Example 25

A polyimide solution having a viscosity of 2051 mPa·sec was prepared by dissolving 15.2% by weight of polyimide (the aforesaid formula (6), weight-average molecular weight Mw=145,000). A test film with a polyimide layer having a thickness of 3 μm was produced in the same manner as in Example 12, except that this polyimide solution is used as a coating liquid, and a slit die coater having D2=100 μm, D1−D2=50 μm and a distance between the die lips of 0.8 mm, and having an inner leading end of the downstream die lip being R-processed with a curvature radius of 0.5 mm is used.

It has been found that although the produced test film has somewhat streaky interference unevenness in some portions, it has a good appearance with only gentle interference unevenness found in the other portions. This film remains excellent even when compared with the appearance of a test film produced by a die lip of such as Example 12 which is not R-processed.

### Example 26

A test film with a polyimide layer having a thickness of 3 μm was produced in the same manner as in Example 1, except that a slit die coater having D2=100 μm, D1−D2=50 μm and a distance between the die lips of 0.8 mm, and having an inner leading end of the downstream die lip being R-processed with a curvature radius of 0.3 mm is used.

It has been found that the produced test film has no streaky interference unevenness observable with eyes and has a remarkably excellent appearance. This film remains excellent even when compared with the appearance of a test film produced by a die lip of such as Example 1 which is not R-processed.

### Example 27

A test film with a polyimide layer having a thickness of 3 μm was produced in the same manner as in Example 2, except that a slit die coater having D2=100 μm, D1−D2=30 μm and a distance between the die lips of 0.8 mm, and having an inner leading end of the downstream die lip being R-processed with a curvature radius of 0.3 mm is used.

It has been found that the produced test film has no streaky interference unevenness observable with eyes and has a remarkably excellent appearance. This film remains excellent even when compared with the appearance of a test film produced by a die lip of such as Example 2 which is not R-processed. This film remains excellent even when compared with the appearance of a test film produced by a die lip of such as Example 2 which is not R-processed.

### Example 28

A test film with a polyimide layer having a thickness of 3 μm was produced in the same manner as in Example 3, except that a slit die coater having D2=60 μm, D1−D2=10 μm and a distance between the die lips of 0.8 mm, and having an inner leading end of the downstream die lip being R-processed with a curvature radius of 0.3 mm is used.

It has been found that although gentle streaky interference unevenness is slightly found in some portions of the produced test film, no interference unevenness observable with eyes is found in the other portions and thus a remarkably excellent appearance is obtained. This film remains excellent even when compared with the appearance of a test film produced by a die lip of such as Example 3 which is not R-processed.

### Comparative Example 7

A polyimide solution having a viscosity of 80 mPa·sec was prepared by dissolving 10% by weight of polyimide (the aforesaid formula (6), weight-average molecular weight Mw=85,000). A test film with a polyimide layer having a thickness of 3 g/m was produced in the same manner as in Example 1, except that this polyimide solution is used as a coating liquid, and a slit die coater having D2=100 g/m, D1−D2=50 μm and a distance between the die lips of 0.8 mm, and having an inner leading end of the downstream die lip being R-processed with a curvature radius of 0.5 mm is used.

It has been found that although the produced test film has portions having a good appearance with no practical problem, it has portions with significant streaky interference unevenness and therefore the appearance is not so good.

### Comparative Example 8

A polyimide solution having a viscosity of 20 mPa·sec was prepared by dissolving 10% by weight of polyimide (the aforesaid formula (6), weight-average molecular weight Mw=55,000). A test film with a polyimide layer having a thickness of 3 μm was produced in the same manner as in Example 1, except that this polyimide solution is used as a coating liquid, and a slit die coater having D2=100 μm, D1−D2=50 μm and a distance between the die lips of 0.8 mm, and having an inner leading end of the downstream die lip being R-processed with a curvature radius of 0.5 mm is used.

It has been found that the produced test film has portions with significant streaky interference unevenness and therefore the appearance is poor.

The producing conditions and the evaluation results are shown in Tables 1-5. Indicators shown in the Tables indicating the evaluation of the appearance are determined according to the following evaluation standard.

Grade 5: Remarkably excellent appearance with no streaky interference unevenness observable with eyes

Grade 4: Excellent appearance with only gentle streaky interference unevenness slightly observed

Grade 3: Good appearance with no practical problem, although streaky interference unevenness is slightly observed

Grade 2: Poor appearance with practical problem, having portions with significant streaky interference unevenness

Grade 1: Extremely poor appearance, in which there are clearly found thin streaky interference unevenness in the entire area and thick streaky interference unevenness in some portions

The evaluation is made for the entire film, and when partially different, plural evaluations (e.g., Grade 2 and Grade 3) exist, an evaluated grade is represented by an intermediate value (e.g., Grade 2.5).

TABLE 1

| | | | | Comp. | Comp. | | | |
|---|---|---|---|---|---|---|---|---|
| | Example 1 | Example 2 | Example 3 | example 1 | example 2 | Example 4 | Example 5 | Example 6 |
| D2 [μm] | 100 | 100 | 60 | 100 | 30 | 100 | 100 | 100 |
| D1-D2 [μm] | 50 | 30 | 10 | −20 | 30 | 50 | 50 | 50 |
| R-process | 0 | 0 | 0 | 0 | 0 | 0 | 0 | 0 |
| [mm] | | | | | | | | |
| Substrate | PET | PET | PET | PET | PET | TAC | TAC | PET |
| PI | 140000 | 140000 | 140000 | 140000 | 140000 | 140000 | 140000 | 102000 |
| molecular | | | | | | | | |
| weight | | | | | | | | |
| PI % by | 10 | 10 | 10 | 10 | 10 | 10 | 10 | 10.7 |
| weight | | | | | | | | |
| Solvent | MIBK | MIBK | MIBK | MIBK | MIBK | MIBK | Ethyl | MIBK |
| | | | | | | | acetate | |
| Viscosity | 200 | 200 | 200 | 200 | 200 | 200 | 200 | 110 |
| [mPa · s] | | | | | | | | |
| Evaluation | 4 | 3.5 | 3.5 | — | 1 | 4 | 2.5 | 3 |
| of | | | | | | | | |
| appearance | | | | | | | | |

TABLE 2

| | | | | Example | Example | Example | Example |
|---|---|---|---|---|---|---|---|
| | Example 7 | Example 8 | Example 9 | 10 | 11 | 12 | 13 |
| D2 [μm] | 100 | 100 | 100 | 100 | 100 | 100 | 100 |
| D1-D2 [μm] | 50 | 50 | 50 | 50 | 50 | 50 | 100 |
| R-process | 0 | 0 | 0 | 0 | 0 | 0 | 0.5 |
| [mm] | | | | | | | |
| Substrate | PET | PET | PET | PET | PET | PET | PET |
| PI | 102000 | 102000 | 145000 | 145000 | 145000 | 145000 | 140000 |
| molecular | | | | | | | |
| weight | | | | | | | |
| PI % by | 12.5 | 15.2 | 8.4 | 11.1 | 12.9 | 15.2 | 10 |
| weight | | | | | | | |
| Solvent | MIBK | MIBK | MIBK | MIBK | MIBK | MIBK | MIBK |
| Viscosity | 267 | 593 | 104 | 320 | 829 | 2051 | 200 |
| [mPa · s] | | | | | | | |
| Evaluation | 4.5 | 2.5 | 2.5 | 4.5 | 4.5 | 2.5 | 3.5 |
| of | | | | | | | |
| appearance | | | | | | | |

TABLE 3

| | Comp. | Comp. | Example | Example | Example | Comp. | Comp. |
|---|---|---|---|---|---|---|---|
| | example 3 | example 4 | 14 | 15 | 16 | example 5 | example 6 |
| D2 [μm] | 100 | 100 | 100 | 100 | 60 | 100 | 30 |
| D1-D2 [μm] | 210 | 0 | 50 | 30 | 10 | −20 | 30 |
| R-process | 0.5 | 0.5 | 0.5 | 0.5 | 0.5 | 0.5 | 0.5 |
| [mm] | | | | | | | |
| Substrate | PET | PET | PET | PET | PET | PET | PET |
| PI | 140000 | 140000 | 140000 | 140000 | 140000 | 140000 | 14000 |
| molecular | | | | | | | |
| weight | | | | | | | |
| PI % by | 10 | 10 | 10 | 10 | 10 | 10 | 10 |
| weight | | | | | | | |
| Solvent | MIBK | MIBK | MIBK | MIBK | MIBK | MIBK | MIBK |
| Viscosity | 200 | 200 | 200 | 200 | 200 | 200 | 200 |
| [mPa · s] | | | | | | | |
| Evaluation | — | 2 | 4.5 | 4.5 | 4 | — | 1 |
| of | | | | | | | |
| appearance | | | | | | | |

TABLE 4

| | Example | Example | Example | Example | Example | Example | Example |
|---|---|---|---|---|---|---|---|
| | 17 | 18 | 19 | 20 | 21 | 22 | 23 |
| D2 [μm] | 100 | 100 | 100 | 100 | 100 | 100 | 100 |
| D1-D2 [μm] | 50 | 50 | 50 | 50 | 50 | 50 | 50 |
| R-process | 0.5 | 0.5 | 0.5 | 0.5 | 0.5 | 0.5 | 0.5 |
| [mm] | | | | | | | |
| Substrate | TAC | TAC | PET | PET | PET | PET | PET |
| PI | 140000 | 140000 | 102000 | 102000 | 102000 | 145000 | 145000 |
| molecular | | | | | | | |
| weight | | | | | | | |
| PI % by | 10 | 10 | 10.7 | 12.5 | 15.2 | 8.4 | 11.1 |
| weight | | | | | | | |
| Solvent | MIBK | Ethyl | MIBK | MIBK | MIBK | MIBK | MIBK |
| | | acetate | | | | | |
| Viscosity | 200 | 200 | 110 | 267 | 593 | 104 | 320 |
| [mPa · s] | | | | | | | |
| Evaluation | 4.5 | 2.5 | 3.5 | 5 | 3.5 | 3 | 5 |
| of | | | | | | | |
| appearance | | | | | | | |

TABLE 5

| | Example | Example | Example | Example | Example | Comp. | Comp. |
|---|---|---|---|---|---|---|---|
| | 24 | 25 | 26 | 27 | 28 | example 7 | example 8 |
| D2 [μm] | 100 | 100 | 100 | 100 | 60 | 100 | 100 |
| D1-D2 [μm] | 50 | 50 | 50 | 30 | 10 | 50 | 50 |
| R-process | 0.5 | 0.5 | 0.3 | 0.3 | 0.3 | 0.5 | 0.5 |
| [mm] | | | | | | | |
| Substrate | PET | PET | PET | PET | PET | PET | PET |
| PI | 145000 | 145000 | 140000 | 140000 | 140000 | 85000 | 55000 |
| molecular | | | | | | | |
| weight | | | | | | | |
| PI % by | 12.9 | 15.2 | 10 | 10 | 10 | 10 | 10 |
| weight | | | | | | | |
| Solvent | MIBK | MIBK | MIBK | MIBK | MIBK | MIBK | MIBK |
| Viscosity | 829 | 2051 | 200 | 200 | 200 | 80 | 20 |
| [mPa · s] | | | | | | | |
| Evaluation | 5 | 3 | 4.5 | 4.5 | 4 | 2 | 1.5 |
| of | | | | | | | |
| appearance | | | | | | | |

1. A process for producing an optical functional film having a polyimide layer, comprising an application step of applying a coating liquid containing polyimide and having a viscosity γ of 100<γ<3000 mPa·s on a substrate film by a die coater having an upstream die lip and a downstream die lip, thereby forming a polyimide layer on the substrate film, in which D2≧50 gm and 0<D1−D2≦200 μm are satisfied, in which D1 represents a distance between a leading end of the upstream die lip and the substrate film and D2 represents a distance between a leading end of the downstream die lip and the substrate film.

2. The process for producing an optical functional film according to claim 1, wherein the coating liquid contains methyl isobutyl ketone.

3. The process for producing an optical functional film according to claim 1, wherein the concentration of polyimide in the coating liquid is 5 to 20% by weight.

4. The process for producing an optical functional film according to claim 1, wherein an inner leading end of at least one of the upstream die lip and the downstream die lip is R-processed with a curvature radius of 0.2 to 1.0 mm.

5. The process for producing an optical functional film according to claim 1, wherein the dried thickness of the polyimide layer formed by the application step is 30 μm or smaller.

6. An optical functional film produced by the method according to claim 1.

7. A polarizing plate comprising the optical functional film according to claim 6.

8. An optical element comprising the optical functional film according to claim 6.

9. An image display device comprising the optical functional film according to claim 6.
